(19) United States
(12) Patent Application Publication
(10) Pub. No.: US 2007/0285586 A1
(43) Pub. Date: Dec. 13, 2007

(54) Drive circuit for digital light projection light engine

(75) Inventor: Brent Hoffman, Mooresville, IN (US)

Correspondence Address: FLETCHER YODER, P.O. BOX 692289, HOUSTON, TX, 77269-2289, US

(73) Assignee: Schenzhen TCL New Technology LTD

(21) Appl. No.: 11/809,385

(22) Filed: Jun. 1, 2007

Related U.S. Application Data
(60) Provisional application No. 60/810,327, filed on Jun. 2, 2006.

(51) Int. Cl. H04N 9/31

(52) U.S. Cl. 348/744

(57) ABSTRACT

A video system in accordance with an exemplary embodiment of the present invention comprises a light engine that is adapted to produce a light output. The exemplary video system additionally comprises an actuator that is adapted to drive the light engine, and a drive circuit that is adapted to produce an actuator analog waveform to drive the actuator, the drive circuit including a programmable waveform generator that produces digital data representative of a logical transition and a filter that filters the digital data to produce the actuator analog waveform.

### CROSS REFERENCE TO RELATED APPLICATION

This application claims priority based on U.S. Provisional Application Ser. No. 60/810,327 filed on Jun. 2, 2006, which is incorporated by reference as though completely set forth herein.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many televisions employ a technology known as digital light projection (DLP). DLP television systems typically employ a light engine to generate white or colored light that can be employed by an imaging system to create a video image. In a DLP light engine that utilizes “smooth picture” technology, drive circuitry is typically used to generate a rolled-off parabola-shaped waveform in order to drive an actuator associated with the light engine. This drive circuitry typically includes a digital-to-analog (D/A) converter or a microprocessor. In one known system, an 8-bit output of a waveform generator is connected to a digital-to-analog (D/A) converter or processor in order to generate the proper waveform to drive the actuator. Elimination of the D/A converter or processor would save overall system cost.

### BRIEF DESCRIPTION OF THE DRAWINGS

In the drawings:

FIG. 1 is a block diagram of a video unit in accordance with an exemplary embodiment of the present invention; and

FIG. 2 is a block diagram of a drive circuit in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

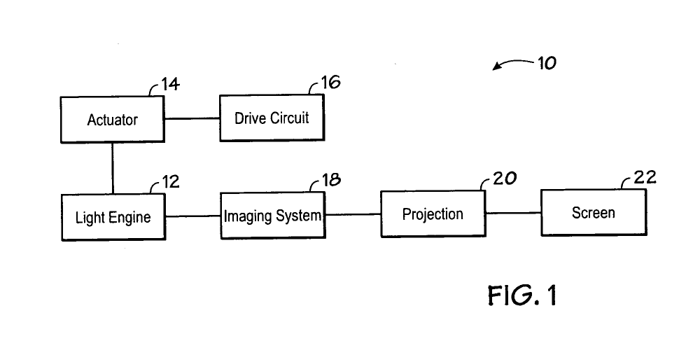

Turning initially to FIG. 1, a block diagram of a video unit in accordance with one embodiment of the present invention is illustrated and generally designated by a reference numeral 10. In the illustrated embodiment, the video unit 10 may comprise a Digital Light Processing (“DLP”) projection television or projector or the like. In another embodiment, the video unit 10 may comprise a liquid crystal display (“LCD”) projection television or projector or the like. In still other embodiments, the video unit 10 may comprise another suitable form of projection television or display.

The video unit 10 includes a light engine 12. The light engine 12 is associated with an actuator 14, which is operated by a drive circuit 16. The light engine 12 is configured to generate white or colored light that can be employed by an imaging system 18 to create a video image. The light engine 12 may include any suitable form of lamp or bulb capable of projecting white or generally white light. In one embodiment, the light engine 12 may be a high intensity light source, such as a metal halide lamp or a mercury vapor lamp. For example, the light engine 12 may include an ultra high performance (“UHP”) lamp produced by Philips Electronics. The light engine 12 may also include a component configured to convert the projected white light into colored light, such as color wheels, dichroic mirrors, polarizers, and filters. Moreover, in alternate embodiments, the light engine 12 may include components capable of generating color light, such as light emitting diodes.

The light engine 12 may be configured to project, shine, or focus colored light at the imaging system 18. The imaging system 18 may be configured to employ the colored light to create images suitable for display on a screen 22. The imaging system 18 may be configured to generate one or more pixel patterns that can be used to calibrate pixel shifting in the video unit 10. In one embodiment, the imaging system 18 comprises a DLP imaging system that employs one or more DMDs to generate a video image using the colored light. In another embodiment, the imaging system may employ an LCD projection system. It will be appreciated, however, that the above-described exemplary embodiments are not intended to be exclusive, and that alternate embodiments, any suitable form of imaging system 18 may be employed in the video unit 10.

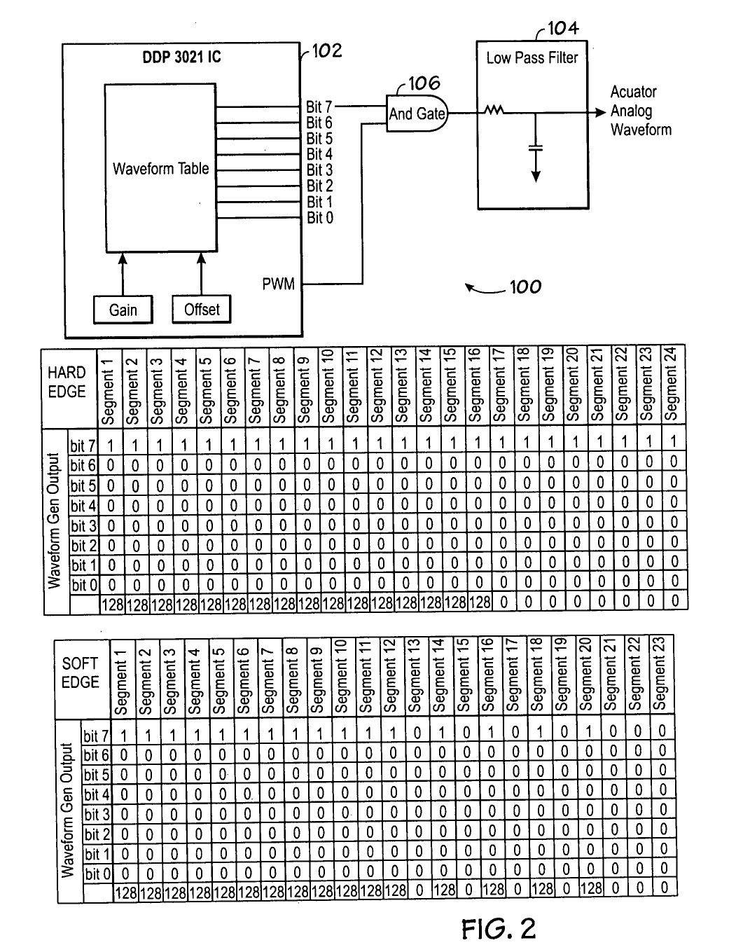

FIG. 2 is a block diagram of a drive circuit in accordance with an exemplary embodiment of the present invention. The drive circuit is generally referred to by the reference number 100. The drive circuit 100 illustrated in FIG. 2 may comprise a portion of the drive circuit 16 (FIG. 1). The drive circuit comprises a programmable waveform generator 102 that may be employed to drive the actuator 14 (FIG. 1) associated with the light engine 12 (FIG. 1).

The programmable waveform generator 102 may be adapted to operate with a DLP chipset, such as the DLP chipset manufactured and sold by Texas Instruments (DDP3021). An exemplary embodiment of the present invention utilizes the waveform generator 102 to drive a simple low pass filter 104 to generate the appropriate waveform.

The programmable waveform generator 102 may be programmed to define specific rising and falling edges to drive an actuator with good performance (minimal or no overshoot or ringing). In an exemplary embodiment of the present invention, the output of the programmable waveform generator 102 is defined by the number of segments (S), the length of each segment (t), and a table containing S 8-bit values. When triggered by a smooth picture sync, the generator will output the first value in the table for t seconds, and then output the next value for t seconds, and so forth until the last value is outputted. The last value is held until the next smooth picture sync occurs, the table is outputted again, but this time in reverse order so that both rising and falling edges of the actuator waveform is present.

In an exemplary embodiment of the present invention, only one output bit is used from the waveform table, as shown in FIG. 2. The bit changes from state 1 at the beginning of the table to state 0 at the end of the table. This bit is then low pass filtered to create softer edges. The first waveform table example set forth in FIG. 2 shows a hard edge, so that the analog output is the step response of the low pass filter. The edges of the waveform can be further defined by inserting a number of quench pulses in the table so that the rising and falling edges of the waveform can be slowed down. The edge segment length may be defined so that these quench pulses are also filtered, resulting in a smooth waveform. This is shown in the second table example of FIG. 2 (soft edge).

In an exemplary embodiment of the present invention, the amplitude of the analog signal can be controlled by “anding” the generator output with a high frequency (much higher than the edge segment length) pulse width modulated (PWM) signal. In the exemplary embodiment shown in FIG. 2, the PWM signal and the output of the programmable waveform generator 102 are both delivered as inputs to an AND gate 106. The output of the AND gate 106 is delivered to the low pass filter 104.

The high frequency PWM may be filtered by a low pass filter, as well. When the on-time of the PWM is 100%, the analog output will be full amplitude, and when the on-time is 0%, the analog output will be 0, and be linear in between these two states.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video system, comprising:
a light engine that is adapted to produce a light output;
an actuator that is adapted to drive the light engine; and
a drive circuit that is adapted to produce an actuator analog waveform to drive the actuator, the drive circuit including a programmable waveform generator that produces digital data representative of a logical transition and a filter that filters the digital data to produce the actuator analog waveform.

2. The video system recited in claim 1, comprising an AND-gate that is adapted to receive output from the programmable waveform generator and a pulse width modulated signal and to deliver an AND-gate output signal to the filter.

3. The video system recited in claim 1, wherein the programmable waveform generator is adapted to produce an output that comprises a predetermined number of data segments.

4. The video system recited in claim 3, wherein the programmable waveform generator is adapted to produce an output corresponding to each one of the predetermined number of data segments for a predetermined time period.

5. The video system recited in claim 3, wherein the programmable waveform generator is adapted to output data corresponding to each one of the predetermined number of data segments in a forward order.

6. The video system recited in claim 5, wherein the programmable waveform generator is adapted to output data corresponding to each one of the predetermined number of data segments in a reverse order after outputting data corresponding to each one of the predetermined number of data segments in the forward order.

7. The video system recited in claim 1, wherein the digital data representative of a logical transition is further representative of a smooth transition.

8. The video system recited in claim 1, wherein the video system comprises a digital light projection (DLP) television.

9. A method of operating a video system, comprising:
employing a programmable waveform generator to produce digital data representative of a logical transition; and
filtering the digital data to produce an actuator analog waveform that is adapted to drive a light engine actuator.

10. The method recited in claim 9, comprising performing a logical AND operation on the digital data representative of a logical transition and a pulse width modulated signal prior to filtering the digital data to produce the actuator analog waveform.

11. The method recited in claim 9, wherein the programmable waveform generator is adapted to produce an output that comprises a predetermined number of data segments.

12. The method recited in claim 11, wherein the programmable waveform generator is adapted to produce an output corresponding to each one of the predetermined number of data segments for a predetermined time period.

13. The method recited in claim 11, wherein the programmable waveform generator is adapted to output data corresponding to each one of the predetermined number of data segments in a forward order.

14. The method recited in claim 13, wherein the programmable waveform generator is adapted to output data corresponding to each one of the predetermined number of data segments in a reverse order after outputting data corresponding to each one of the predetermined number of data segments in the forward order.

15. The method recited in claim 9, wherein the digital data representative of a logical transition is further representative of a smooth transition.

16. The method recited in claim 9, wherein the video system comprises a digital light projection (DLP) television.

17. A video system, comprising:
means for producing digital data representative of a logical transition; and
means for filtering the digital data to produce an actuator analog waveform that is adapted to drive a light engine actuator.

18. The video system recited in claim 17, comprising means for performing a logical AND operation on the digital data representative of a logical transition and a pulse width modulated signal prior to filtering the digital data to produce the actuator analog waveform.

19. The video system recited in claim 17, wherein the means for producing digital data is adapted to produce an output that comprises a predetermined number of data segments.

20. The video system recited in claim 19, wherein the means for producing digital data is adapted to produce an output corresponding to each one of the predetermined number of data segments for a predetermined time period.
